(19) United States
(12) Patent Application Publication
(10) Pub. No.: US 2005/0259285 A1
(43) Pub. Date: Nov. 24, 2005

(54) Digital multifunctional imaging apparatus

(75) Inventor: Mikio Shoki, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/132,186

(22) Filed: May 19, 2005

(30) Foreign Application Priority Data
May 19, 2004 (JP) 2004-149710

(51) Int. Cl. H04N 1/50; H04N 1/21; H04N 1/60

(52) U.S. Cl. 358/1.9; 358/502; 358/518; 358/1.16

(57) ABSTRACT

A digital multifunctional apparatus enables to shorten a time lag between scanning of a document for taking an image data by an image sensor to printing an image on a paper sheet by a printing mechanism with reducing cost. An image processor constituted by a hardware circuit converts image data of three primary colors of additive color process of red, green and blue to image data of three primary colors of subtractive color process of cyan, magenta and yellow. The converted image data of each pixel is compared with predetermined threshold values and separately accumulated in one of a plurality of buffers corresponding to the result of comparison with the threshold value. The printing mechanism uses the image data accumulated in the buffers for printing a color image on a paper sheet.

### BACKGROUND OF THE INVENTION

1. Field of the Invention

The present invention relates to a digital multifunctional imaging apparatus (hereafter referred to simply as “digital multifunctional apparatus”) which has a printing function and a scanning function, and is capable of copying a document independently without being connected to an apparatus having a host function such as a personal computer.

2. Description of the Related Art

A digital multifunctional apparatus has an image processing function for enlarging/reducing image data read by an image sensor (scanner unit) in order to adjust the image data to, for example, a size of a printing paper. When a host apparatus such as a personal computer is connected to the digital multifunctional apparatus, such image processing can easily be performed with using a CPU (Central Processing Unit) in the host apparatus. On the other hand, in a digital multifunctional apparatus of called stand-alone type that can copy a document independently, three CPUs are used for scan control, print control and entire control of the digital multifunctional apparatus, respectively, while one DSP (Digital Signal Processor) is used for image processing, in order to perform the copy process without being connected to a host apparatus, or without starting up the host apparatus.

In such an imaging apparatus, the image data of three primary colors of subtractive color process, that is, cyan, magenta and yellow, are generally used for printing an image on a paper sheet, whereas the image data read in an image sensor are of three primary colors of additive color process, that is, red, green, and blue. Therefore, conversion from the image data of three primary colors of additive color process to the image data of three primary colors of subtractive color process is performed as one of image processing carried out in the digital multifunctional imaging apparatus.

A conventional image forming apparatus, for example, shown in Japanese Laid-Open Patent Publication No. 1-200964 distinguishes a pixel which outputs a data of black from others based on an achromatic color signal and a luminance signal. Another conventional image forming apparatus, for example, shown in Japanese Laid-Open Patent Publication No. 2000-287090 prints an image densely on a paper sheet although the contrast of the image data is weak.

However, the above-mentioned conventional digital multifunctional apparatus is configured to perform the image processing through a firmware using the DSP, so that the processing speed depends on the operating frequencies of the CPUs and the DSP in the digital multifunctional apparatus, in which the DSP operates in synchronization with the CPUs. Thus, in order to complete the image processing and start printing operation in a short time, it is necessary to increase the frequencies of the operating clock of the CPUs and the DSP in the digital multifunctional apparatus. For example, the frequency of the operating clock of the three CPUs is required to be about 100 MHz, while the frequency of the operating clock of the DSP is required to be about 200 MHz. Accordingly, it is needed to use many such CPUs and DSP, which are expensive and thus remain an obstacle to cost reduction of the digital multifunctional apparatus. This problem cannot be solved by using the technology disclosed in either one of the above patent publications.

### SUMMARY OF THE INVENTION

An object of the present invention is to provide such a digital multifunctional apparatus that can perform the conversion from the image data of three primary colors of additive color process to the image data of three primary colors of subtractive color process without using expensive high spec CPU and/or DSP with high frequency of the operating clock, so that it enables reduction of cost.

A digital multifunctional imaging apparatus capable of copying a document independently in accordance with an aspect of the present invention comprises: an image sensor for irradiating light onto a document and receiving light reflected from the document so as to read image data of the document; an image processor for performing conversion of image data of three primary colors of additive color process read by the image sensor to image data of three primary colors of subtractive color process; a buffer for temporarily memorizing the image data converted by the image processor; a printing mechanism for printing an image with using the image data memorized in the buffer; a CPU (Central Processing Unit) for controlling the image sensor, the image processor, the buffer and the printing mechanism; and a memory memorizing operating programs of the CPU.

The image sensor reads image data of red, green and blue with each pixel from a document. The image processor is configured by a hardware circuit, calculates an image data of cyan with using only an image data of red read by the image sensor, calculates an image data of magenta with using only an image data of green read by the image sensor, and calculates an image data of yellow with using only an image data of blue read by the image sensor.

With such a configuration, the image processor constituted by a hardware circuit converts image data of three primary colors of additive color process of red, green and blue to image data of three primary colors of subtractive color process of cyan, magenta and yellow. The converted image data of each pixel is compared with predetermined threshold values and separately accumulated in one of a plurality of buffers corresponding to the result of comparison with the threshold value. The printing mechanism uses the image data accumulated in the buffers for printing a color image on a paper sheet. Thus, it is possible that the conversion of image data of three primary colors of additive color process read by the image sensor to image data of three primary colors of subtractive color process can be performed without increasing burden of the CPU, while reading the image data of the document by the image sensor. Since the burden of the CPU can be reduced, it is possible to use an inexpensive CPU having a low operating clock frequency, while reducing time required from reading of the document to printing, thereby making it possible to reduce the cost of the digital multifunctional apparatus.

It is preferable that the printing mechanism has nozzles for emitting colored inks of at least cyan, magenta, yellow and black; and the image processor controls the printing mechanism for emitting black colored ink to a position on a paper sheet corresponding to a pixel in which values of all image data of cyan, magenta and yellow are equal to or larger than a predetermined threshold value, and for emitting one of cyan, magenta and yellow colored inks to a position on the paper sheet corresponding to a pixel in which at least one of values of image data of cyan, magenta and yellow is smaller than the predetermined threshold value.

Alternatively, it is possible that the printing mechanism has nozzles for emitting colored inks of cyan, magenta, yellow, black, light cyan and light magenta; and the image processor controls the printing mechanism for emitting black colored ink to a position on a paper sheet corresponding to a pixel in which values of all image data of cyan, magenta and yellow are equal to or larger than a first threshold value, for emitting one of cyan, magenta and yellow colored inks to a position on the paper sheet corresponding to a pixel in which at least one of values of image data of cyan, magenta and yellow is smaller than the first threshold value, but equal to or larger than a second threshold value, and for emitting light cyan or light magenta colored ink to a position on the paper sheet corresponding to a pixel in which a value of image data of cyan or magenta is smaller than the second threshold value, but equal to or larger than the third threshold value.

### BRIEF DESCRIPTION OF THE DRAWINGS

FIG. 1 is a block diagram showing a configuration of a digital multifunctional apparatus in accordance with an embodiment of the present invention;

FIG. 2 is a circuit diagram schematically showing a configuration of an image processor corresponding to six colors printing mode applied in the digital multifunctional apparatus; and

FIG. 3 is a circuit diagram schematically showing a configuration of an image processor corresponding to four colors printing mode applied in the digital multifunctional apparatus.

### DESCRIPTION OF THE PREFERRED EMBODIMENTS

A preferred embodiment in accordance with the present invention will be described with reference to the drawings.

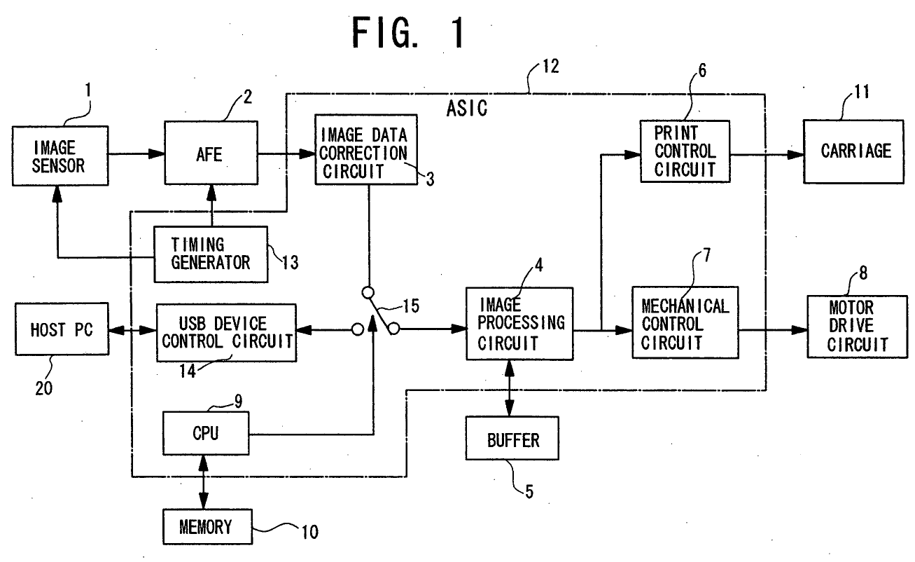

FIG. 1 shows a schematic block diagram of a digital multifunctional apparatus having an inkjet printer mechanism in accordance with the embodiment. The digital multifunctional apparatus comprises: an image sensor 1 for reading image data of a document and converting the read image data into analog electric signals; an analog front-end circuit (AFE) 2 for converting the analog electric signals of the image data read by the image sensor 1 into digital electric signals; an image data correction circuit 3 for correcting the image data output from the AFE 2, if necessary; an image processor (serving as an image processing means) 4 for enlarging/reducing the image data output from the image data correction circuit 3; a buffer (serving as a buffer means) 5 for temporarily memorizing the image data processed by the image processor 4; a print control circuit 6 for controlling motion of a carriage 11 on the basis of the image data memorized in the buffer 5; a mechanical control circuit 7 for mechanically controlling a paper feed motor (not shown), and so on; a motor drive circuit 8 for applying a drive voltage to the paper feed motor, and so on, on the basis of control signals output from the mechanical control circuit 7; a CPU (Central Processing Unit, serving as a control means) 9 for controlling respective elements in the digital multifunctional apparatus; a memory (serving as a memory means) 10 memorizing operating programs of the CPU 9 and various data required for the operation of the CPU 9; the carriage (serving as a printing means) 11 for printing a print based on the image data memorized in the buffer 5; and so on. The CPU 9 controls not only the respective elements as described above such as the image sensor 1, the image processor 4 and the buffer 5, but also other elements such as the carriage 11.

The above-mentioned image data correction circuit 3, the image processor 4, the print control circuit 6, the mechanical control circuit 7 and the CPU 9 are integrated into one-chip ASIC (Application-Specific Integrated Circuit) 12. Note that the CPU 9 used in this embodiment has an operating clock frequency of 48 MHz. The ASIC 12 further has, integrated therein, a timing generator 13 for outputting synchronizing signals to the image sensor 1 and the AFE 2, and also has a USB (Universal Serial Bus) device control circuit 14 which is connected via a USB cable to a host PC (personal computer) 20 to be connected to the digital multifunctional apparatus, and which functions as an interface to the host PC 20.

The image sensor 1 is configured by a CCD (Charge Coupled Device) or a CIS (Contact Image Sensor) each having pixels aligned in a row, and so on. The image sensor 1 irradiates light onto a document, receives light reflected from the document so as to read image data for each line (for example, 5100 pixels), and converts the image data into electric signals. The image data correction circuit 3 performs black level calibration for the image data output from the AFE 2, sensitivity correction for each pixel as well as level correction and gamma correction for each color of RGB (Red, Green and Blue). The image data corrected by the image data correction circuit 3 are output to alternative of the image processor 4 and the USB device control circuit 14 via a switch 15, switching operation of which is controlled by the CPU 9. More specifically, when the switch 15 is turned to the image processor 4, the digital multifunctional apparatus can copy the image data of the document independently. On the other hand, when the switch 15 is turned to the USB device control circuit 14, the image data output from the image data correction circuit 3 are transferred via the USB device control circuit 14 to the host PC 20.

The image processor 4 is configured by a hardware circuit (logic circuit), and performs conversion of the image data of three primary colors of additive color process R, G and B (Red, Green and Blue) outputted from the image data correction circuit 3 to the image data of three primary colors of subtractive color process C, M and Y (Cyan, Magenta and Yellow) responding to a control signal outputted from the CPU 9. The image data performed by the image processor 4 is temporarily memorized in the buffer 5. The conversion of image data by the image processor 4 is realized by calculation of the following simple equations (1) to (3).
C=1−R (1)
M=1−G (2)
Y=1−B (3)

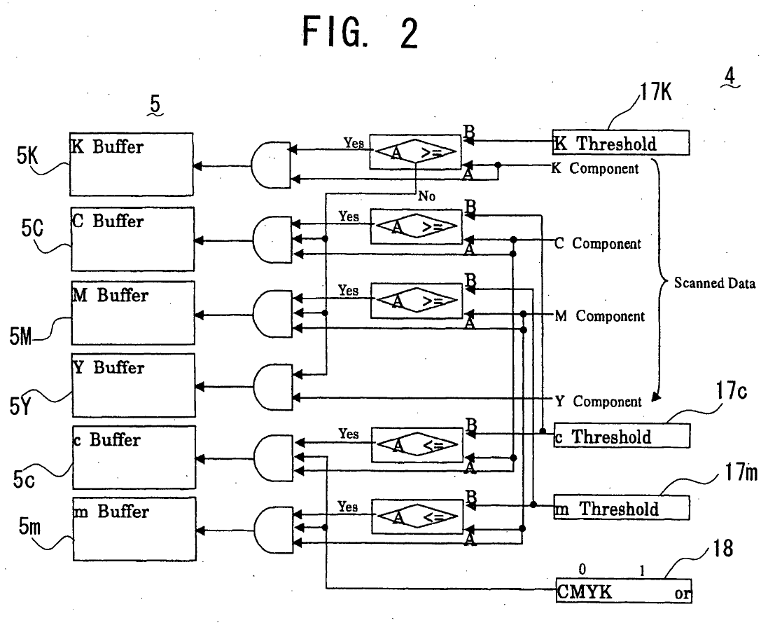

FIG. 2 shows a configuration of the image processor 4 and the buffer 5 corresponding to six colors printing mode. In the six colors printing mode, a color image is printed on a paper sheet with using six colored inks of cyan, magenta, yellow, black, light cyan and light magenta. Light cyan and light magenta have respectively lower density of cyan and magenta. In the digital multifunctional apparatus corresponding to the six colors printing mode, the carriage 11 has nozzles for emitting inks of the six colors. The buffer 5 has a K buffer 5K for accumulating image data of pixels printed by black colored ink, a C buffer 5C for accumulating image data of pixels printed by cyan colored ink, an M buffer 5M for accumulating image data of pixels printed by magenta colored ink, a Y buffer 5Y for accumulating image data of pixels printed by yellow colored ink, a c buffer 5c for accumulating image data of pixels printed by light cyan colored ink and an m buffer Sm for accumulating image data of pixels printed by light magenta colored ink. Image data of cyan, magenta, yellow and black which are converted as above are inputted to the image processor 4. The image data of black is obtained from the image data of cyan, magenta and yellow.

The image processor 4 accumulates image data of pixels, in which values of all image data of cyan, magenta and yellow are equal to or larger than a first threshold value, into the K buffer 5K in order to distinguish the dots printed by black colored ink (Mono Head) from others. With respect to pixels in which value of at least one of image data of cyan, magenta and yellow is smaller than the first threshold value, the image processor 4 further compares the value of the image data of each color with a second threshold value and a third threshold value which are set for each color. The second threshold value is larger than the third threshold value. When the value of the image data of each color is equal to or larger than the second threshold value, the image processor 4 accumulates the image data of the pixels having a value equal to or larger than these threshold values into any one of the C buffer 5C, M buffer 5M and Y buffer 5Y With respect to pixels in which a value of the image data of cyan or magenta is smaller than the second threshold value, but equal to or larger than the third threshold value, the image processor 4 accumulates the image data of pixels into c buffer 5c or m buffer 5m. By such processing, the image data of each pixel is separately accumulated in the buffer of each color. The image data accumulated in each buffer is performed a quasi-halftone processing by a quasi-halftone processing circuit which is additionally mounted in the image processor 4, and used for printing an image on a paper sheet by the carriage 11. The first threshold value is stored, for example, in a K-threshold register 17K The second threshold value and the third threshold value are respectively stored in c-threshold register 17c and m-threshold register 17m.

In the digital multifunctional apparatus in this embodiment, it is possible to print an image on a paper sheet in a four colors printing mode with using four color inks of cyan, magenta, yellow and black. Switching of the printing mode is controlled with using a value allocated to a predetermined bit of a control register 18. In the four colors printing mode, emission of each color ink is controlled with using the image data accumulated in the K buffer 5K, C buffer 5C, M buffer 5M and Y buffer 5Y.

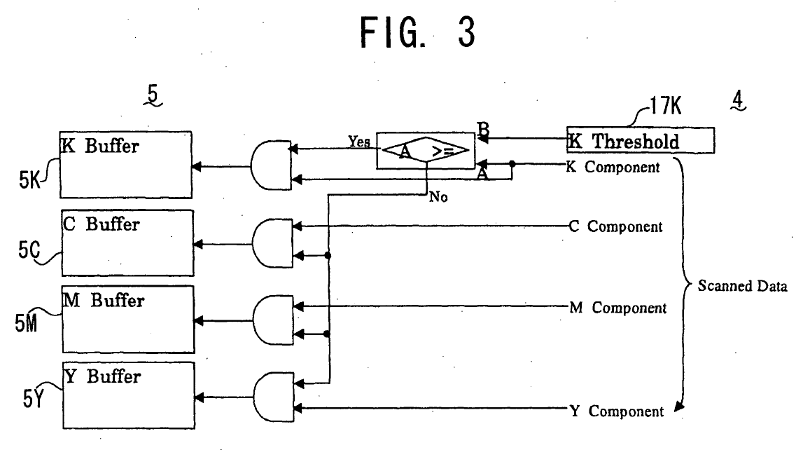

FIG. 3 shows a circuit configuration corresponding to only for colors printing mode, as a modification of the image processor 4 and the buffer 5. In the four colors printing mode, a color image is printed on a paper sheet with using four colored inks of cyan, magenta, yellow and black.

In the digital multifunctional apparatus corresponding to the four colors printing mode, the carriage 11 has nozzles for emitting inks of the four colors. The buffer 5 has a K buffer 5K for accumulating image data of pixels printed by black colored ink, a C buffer 5C for accumulating image data of pixels printed by cyan colored ink, an M buffer 5M for accumulating image data of pixels printed by magenta colored ink, and a Y buffer 5Y for accumulating image data of pixels printed by yellow colored ink. Image data of cyan, magenta, yellow and black which are converted as above are inputted to the image processor 4. The image data of black is obtained from the image data of cyan, magenta and yellow.

The image processor 4 accumulates image data of pixels, in which all of image data of cyan, magenta and yellow is equal to or larger than a first threshold value, into the K buffer 5K in order to distinguish the dots printed by black colored ink (Mono Head) from others. On the other hand, the image data of pixels in which at least one of image data of cyan, magenta and yellow is lower than the first threshold value are accumulated into any one of the C buffer 5C, M buffer 5M and Y buffer 5Y By such processing, the image data of each pixel is separately accumulated in the buffer of each color. The image data accumulated in each buffer is performed a quasi-halftone processing similar to the above-mentioned case, and used for printing an image on a paper sheet by the carriage 11. The first threshold value is stored, for example, in a K-threshold register 17K.

According to the digital multifunctional apparatus as mentioned above, since the image processor 4 is constituted only by a hardware circuit, it is possible that image data of three primary colors of additive color process read by the image sensor 1 is converted to image data of three primary colors of subtractive color process without increasing burden of the CPU 9 while reading an image data of a document. Therefore, it is further possible to use an inexpensive processor with low frequency of operating clock as the CPU 9, while the time lag from reading an imaged data of a document to printing an image on a paper sheet can be shortened. Furthermore, since image data of cyan, magenta and yellow are respectively calculated from only image data of red, green and blue by the image processor 4, it is possible to simplify the constitution of the image processor 4. Consequently, it is possible to reduce the cost of the digital multifunctional apparatus. Still furthermore, the image processor 4 compares he image data of cyan, magenta and yellow with a threshold value, and accumulates the image data of each pixel separately into buffer of each color corresponding to the result of comparison, so that it is possible to obtain an image having a quality like photograph by emitting four or six color inks with using the image data accumulated in the buffers.

The present invention is not limited to the constitution of the above-mentioned embodiment, and it is possible to modify various kinds. For example, the image processor 4 is not limited to perform the color conversion due to calculation with following the above-mentioned equations (1) to (3). The image processor 4 can be constituted by a hardware circuit corresponding to another algorithm, such as calculation with using a predetermined conversion matrix performs the color conversion by another algorithm. The separation of the image data into the buffer of each color is not limited to the constitution shown in FIG. 2 or 3, and it is possible to be performed with a hardware circuit corresponding to another algorithm. Furthermore, the printing mechanism is not limited to the ink-jet, and it is possible to adopt another type of printing mechanism such as a laser beam printer.

This application is based on Japanese patent application 2004149710 filed May 19, 2004 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

1. A digital multifunctional imaging apparatus capable of copying a document independently, comprising:
an image sensor for irradiating light onto a document and receiving light reflected from the document so as to read image data of the document;
an image processor for performing conversion of image data of three primary colors of additive color process read by the image sensor to image data of three primary colors of subtractive color process;
a buffer for temporarily memorizing the image data converted by the image processor;
a printing mechanism for printing an image with using the image data memorized in the buffer;
a CPU (Central Processing Unit) for controlling the image sensor, the image processor, the buffer and the printing mechanism; and
a memory memorizing operating programs of the CPU, wherein
the image sensor reads image data of red, green and blue with each pixel from a document;
the image processor is configured by a hardware circuit, calculates an image data of cyan with using only an image data of red read by the image sensor, calculates an image data of magenta with using only an image data of green read by the image sensor, and calculates an image data of yellow with using only an image data of blue read by the image sensor.

2. The digital multifunctional imaging apparatus in accordance with claim 1, wherein
the printing mechanism has nozzles for emitting colored inks of at least cyan, magenta, yellow and black; and
the image processor controls the printing mechanism for emitting black colored ink to a position on a paper sheet corresponding to a pixel in which values of all image data of cyan, magenta and yellow are equal to or larger than a predetermined threshold value, and for emitting one of cyan, magenta and yellow colored inks to a position on the paper sheet corresponding to a pixel in which at least one of values of image data of cyan, magenta and yellow is smaller than the predetermined threshold value.

3. The digital multifunctional imaging apparatus in accordance with claim 1, wherein
the printing mechanism has nozzles for emitting colored inks of cyan, magenta, yellow, black, light cyan and light magenta; and
the image processor controls the printing mechanism for emitting black colored ink to a position on a paper sheet corresponding to a pixel in which values of all image data of cyan, magenta and yellow are equal to or larger than a first threshold value, for emitting one of cyan, magenta and yellow colored inks to a position on the paper sheet corresponding to a pixel in which at least one of values of image data of cyan, magenta and yellow is smaller than the first threshold value, but equal to or larger than a second threshold value, and for emitting light cyan or light magenta colored ink to a position on the paper sheet corresponding to a pixel in which a value of image data of cyan or magenta is smaller than the second threshold value, but equal to or larger than the third threshold value.

4. A digital multifunctional imaging device capable of copying a document independently, comprising:
an image sensor for irradiating light onto a document and receiving light reflected from the document so as to read image data of the document;
an image processing means for performing conversion of image data of three primary colors of additive color process read by the image sensor to image data of three primary colors of subtractive color process;
a buffer means for temporarily storing the image data converted by the image processing means;
a printing means for printing an image with using the image data stored in the buffer means;
a control means for controlling the image sensor, the image processing means, the buffer means and the printing means; and
a memory means memorizing operating programs of the control means, wherein
the image sensor reads image data of red, green and blue with each pixel from a document;
the printing means has nozzles for emitting colored inks of cyan, magenta, yellow, black, light cyan and light magenta;
the control means is configured by a single CPU (Central Processing Unit),
the image processing means is formed of a hardware circuit, calculates an image data of cyan with using only an image data of red read by the image sensor, calculates an image data of magenta with using only an image data of green read by the image sensor, and calculates an image data of yellow with using only an image data of blue read by the image sensor, and accumulates the calculated image data into the buffer means;
the image processing means controls the printing means for emitting black colored ink to a position on a paper sheet corresponding to a pixel in which values of all image data of cyan, magenta and yellow are equal to or larger than a first threshold value, for emitting one of cyan, magenta and yellow colored inks to a position on the paper sheet corresponding to a pixel in which at least one of values of image data of cyan, magenta and yellow is smaller than the first threshold value, but equal to or larger than a second threshold value, and for emitting light cyan or light magenta colored ink to a position on the paper sheet corresponding to a pixel in which a value of image data of cyan or magenta is smaller than the second threshold value, but equal to or larger than the third threshold value, so that the conversion of image data of three primary colors of additive color process read by the image sensor to image data of three primary colors of subtractive color process can be performed without increasing burden of the CPU, while reading the image data of the document by the image sensor, and a color image is formed on a paper sheet with using six color inks.
